(19) United States
(12) Patent Application Publication
(10) Pub. No.: US 2007/0187912 A1
(43) Pub. Date: Aug. 16, 2007

(54) Wheeled hamper with telescoping handle

(76) Inventors: Raymond Taulman, McDonough, GA (US); Melodie Taulman, McDonough, GA (US)

Correspondence Address: WITHERS & KEYS, LLC, P. O. BOX 2049, MCDONOUGH, GA, 30253, US

(21) Appl. No.: 11/356,342

(22) Filed: Feb. 16, 2006

(51) Int. Cl. B62B 1/00

(52) U.S. Cl. 280/47.26

(57) ABSTRACT

Mobile laundry hampers and methods of using mobile laundry hampers are disclosed.

### FIELD OF THE INVENTION

The present invention relates to a laundry hamper for residential or commercial use.

### BACKGROUND OF THE INVENTION

Hampers are used in practically every household, but unfortunately, there has been little development in hamper design or construction to make it easier for someone to move a hamper full of laundry or cleaning supplies. Though virtually every hamper has a handle, the hamper is otherwise unwieldy to move form one location to another when full of laundry or laundry supplies. The bending and stooping necessary to pick up and carry a traditional hamper can lead to back problems and other ailments for users (particularly for taller users).

There exists a need in the art for a mobile laundry hamper that is both easy to move and is adjustable based on the height of the user.

### SUMMARY OF THE INVENTION

The present invention addresses some of the difficulties and problems discussed above by the discovery of a hamper with wheels and a telescoping handle.

Accordingly, in one exemplary embodiment, the present invention is directed to a hamper comprising at least one hamper compartment comprising a bottom side wall, one or more vertical walls extending upward from the bottom side wall, and a compartment opening positioned within a vertical wall or positioned opposite the bottom side wall, the compartment opening being sized so that one or more pieces of clothing can be inputted into the at least one hamper compartment through the compartment opening; two or more wheels affixed to the at least one hamper compartment so as to provide mobility to the at least one hamper compartment; and a telescoping handle assembly affixed to the one or more vertical walls, the telescoping handle assembly being movable from a first position in which a major portion of a length of the telescoping handle assembly is positioned below an upper periphery of the one or more vertical walls to a second position in which a major portion of a length of the telescoping handle assembly is positioned above the upper periphery of the one or more vertical walls. The exemplary hamper may further comprise a number of additional components or features including, but not limited to, a lid, a plurality of apertures, one or more dividers to subdivide the laundry area, and one or more drawers, slots or pockets for holding laundry supplies.

The present invention is also directed to a method of a method of moving laundry. In one exemplary embodiment, the method of moving laundry comprising the steps of (i) loading laundry into a hamper comprising at least one hamper compartment comprising a bottom side wall, one or more vertical walls extending upward from the bottom side wall, and a compartment opening positioned within a vertical wall or positioned opposite the bottom side wall, the compartment opening being sized so that one or more pieces of clothing can be inputted into the at least one hamper compartment through the compartment opening; two or more wheels affixed to the at least one hamper compartment so as to provide mobility to the at least one hamper compartment; and a telescoping handle assembly affixed to the one or more vertical walls, the telescoping handle assembly being movable from a first position in which a major portion of a length of the telescoping handle assembly is positioned below an upper periphery of the one or more vertical walls to a second position in which a major portion of a length of the telescoping handle assembly is positioned above the upper periphery of the one or more vertical walls; (ii) extending the telescoping handle assembly, if necessary, to move the telescoping handle assembly into the second position; and (iii) moving the hamper from one location to another location by pushing or pulling on the telescoping handle assembly.

These and other features and advantages of the present invention will become apparent after a review of the following detailed description of the disclosed embodiments and the appended claims.

### BRIEF DESCRIPTION OF THE FIGURES

FIG. 1 depicts a view of an exemplary hamper of the present invention when the handle is in a raised position;

FIG. 2 depicts a partial cut-away perspective view of another exemplary hamper of the present invention, wherein the exemplary hamper comprises a drawer, a pocket/slot, and a divider;

FIG. 3 depicts a side view of the exemplary hamper of FIG. 1;

FIG. 4 depicts a rear view of the exemplary hamper of FIG. 1;

FIG. 5 depicts a partial cut-away view of the handle and lid portion of an exemplary embodiment of the present invention when the handle is in a lowered/stowed position and the lid closed;

FIG. 6 depicts a partial cut-away view of the handle and lid portion of the exemplary embodiment of FIG. 5 wherein the handle is in the raised position and the lid is raised;

FIG. 7 depicts a view of another exemplary hamper of the present invention when the handle is in the raised position and the hamper comprises wicker; and

FIG. 8 depicts a partial sectional view along line A-A of FIG. 3.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to hampers and methods of using hampers. The disclosed hampers may be used to transport laundry. Further, the invention could be used to transport other materials such as laundry supplies and other household goods.

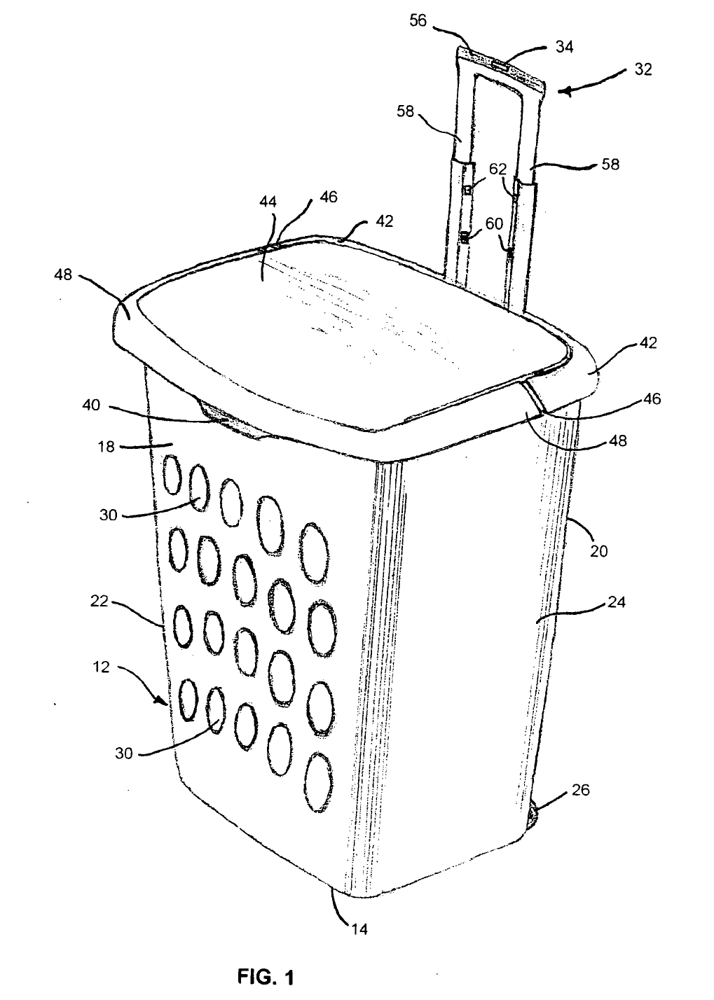

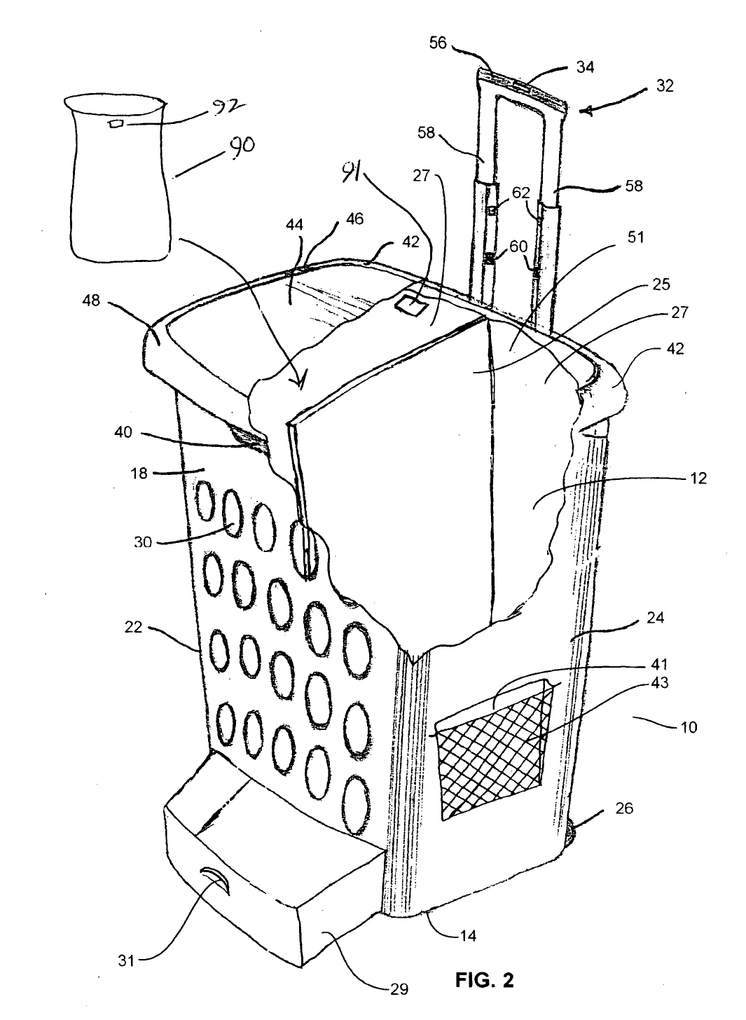

The hampers of the present invention comprise one or more components. One exemplary hamper 10 of the present invention is shown in FIG. 1. Exemplary hamper 10 comprises hamper compartment 12 (see FIG. 2) with bottom side wall 14, front wall 18, back wall 20, first side wall 22, and second side wall 24 such that hamper 10 has at least one compartment opening 51 (see FIG. 2). Though illustrated with four side walls 18, 20, 22, 24, hamper compartment 12 may comprise any number of side walls. For example, hamper compartment 12 may comprise one side wall when hamper compartment 12 is round, or it may comprise three side walls when hamper compartment 12 is triangular. Thus, hamper compartment 12 may be of any desired shape with any number and configuration of sidewalls. Also note that although shown with compartment opening 51 being situated at the top of hamper 10, one or more compartment openings 51 may be situated in one or more of the sidewalls as well. Hamper 10 also includes a telescoping handle assembly 28 and may include a cover or lid 16, which may cover compartment opening 51 as discussed in more detail below.

In a further embodiment illustrated in FIG. 2, hamper 10 may also comprise one or more dividers 25 that subdivide hamper compartment 12 into several hamper compartments or sub-compartments 27 so that a user may sort their laundry when putting laundry into hamper 10. Though shown with divider 25 being situated vertically, any suitable number of vertical, horizontal or angled dividers may be included within hamper 10. It is desirable for divider(s) 25 be removable for cleaning and other purposes.

FIG. 2 also illustrates a drawer 29, which may be utilized to store laundry cleaning supplies and other materials, i.e., detergent, stain remover, fabric softener, baking soda or other odor removers, etc. Though illustrated with drawer 29, and corresponding knob 31 being situated at the base of hamper 10, it may be sized, shaped and positioned in any location within hamper 10. Although not visible in FIG. 2, it is desirable for divider 25 or other wall or barrier, when present, to be situated above the drawer so that the laundry is separated from the supplies in the drawer.

The exemplary embodiment of FIG. 2 further illustrates a pocket or slot 41, which may be within hamper compartment 12 or on the exterior of hamper 10 as shown. In this exemplary embodiment, exemplary hamper 10 includes elastic netting 43 so that a user may view the contents of pocket 41 without removing them. Pocket/slot 41 may be shaped and positioned as desired. One exemplary location for pocket 41 is in the lid of hamper 10 so that pocket 41 can hold deodorizer or an odor absorbing material to retain smells or odors that may be associated with dirty laundry.

As illustrated in the exemplary embodiments of FIGS. 1 and 2, it is desirable for at least one of side walls 14, 18, 20, 22, 24 of hamper 10 to include a plurality of apertures 30 in order for air to flow freely in and out of hamper 10 to help alleviate a build up of undesirable odors. These apertures may also include screening or other material to help trap odors while allowing humidity and other gases and liquids to pass through unimpeded so that clothes in the hamper do not become mildewed. In one exemplary embodiment, bottom side wall 14, one or more vertical walls 18, 20, 22 and 24, or both has a plurality of apertures 30 therethrough.

It should be noted that each of apertures 30 may have any dimensions suitable for providing air flow through at least one of sidewalls 14, 18, 20, 22, 24 of hamper 10. For example, when one or more of side walls 14, 18, 20, 22, 24 of hamper 10 comprises wicker, apertures 30 comprise openings between individual strands of wicker material. When one or more of side walls 14, 18, 20, 22, 24 of hamper 10 comprises a plastic material (e.g., a molded side wall), apertures 30 comprise openings thermoformed within the plastic material or punched through the plastic material after a thermoforming process. In one exemplary embodiment, each of apertures 30 has an average aperture area of at least about ¼ square inch. In a further exemplary embodiment, each of apertures 30 has an average aperture area of at least about 1 square inch. However, it should be understood that each of apertures 30 may have any desired average aperture area.

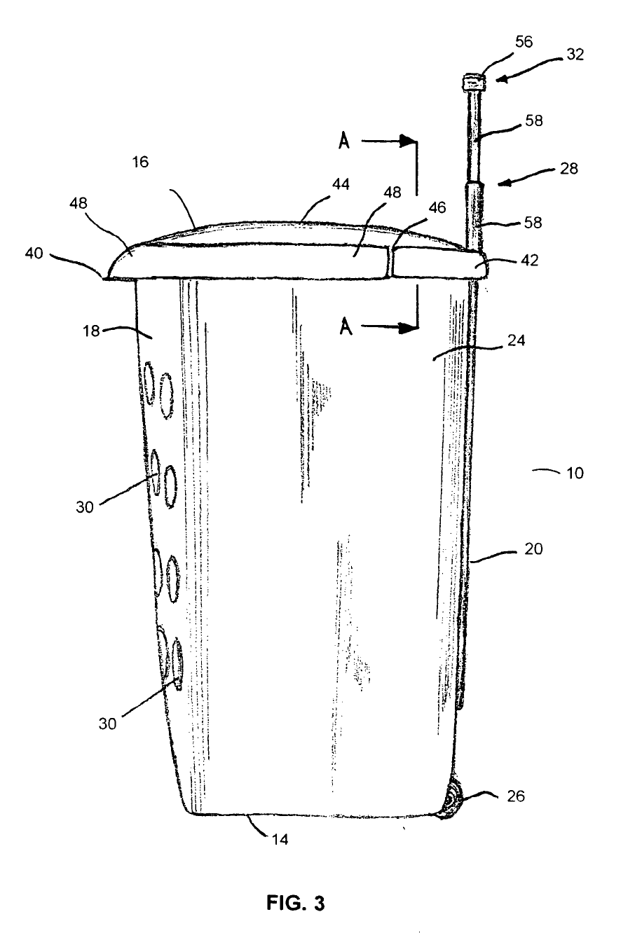

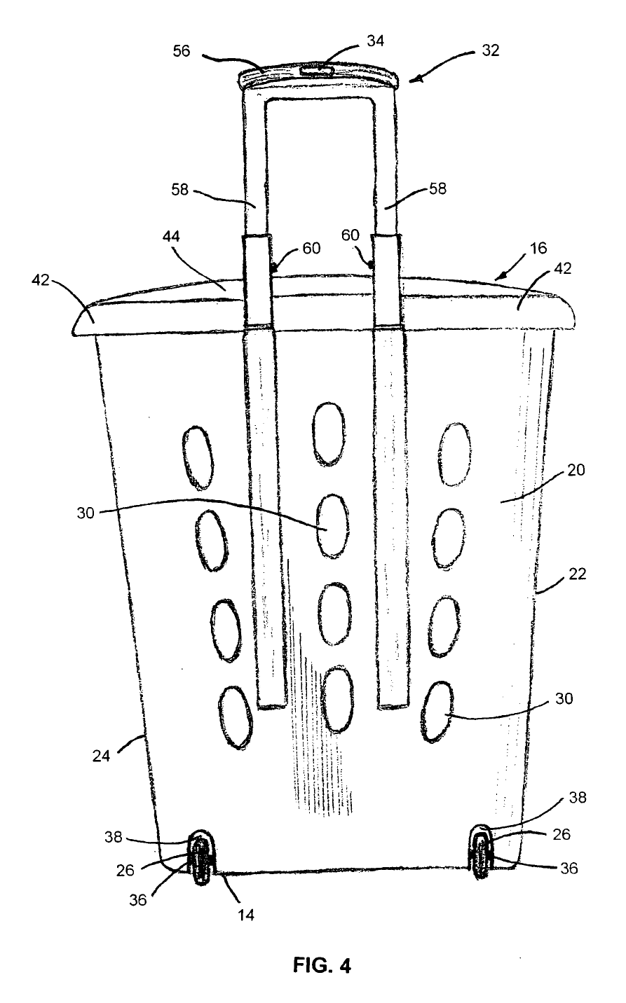

The exemplary embodiment of FIGS. 3 and 4 show a corner junction of bottom side wall 14, back wall 20 and inward from each side wall 22, 24 molded areas 38 that contain wheels 26 partially recessed therein. Wheels 26 are rotatably carried by axels 36, which may be installed in molded area 38 of hamper 10. Because wheels 26 are desirably removable from molded areas 38 of hamper 10, and because walls 18, 20, 22, and 24 desirably taper slightly outwardly from their bottoms to their tops, hamper compartment 12 can be nested within a like body portion of another hamper for ease of shipment.

As shown in FIG. 3, the upper periphery or top of back wall 20 may be provided with a skirt 42, which extends around the top rear corners and slightly above side walls 22 and 24. Also shown is a cover or lid 16, which may include a slightly domed lid surface 44, which may in turn have a contoured gripping tongue 40 (see FIGS. 1 and 3) protruding from skirt 48. The majority of the periphery or surface 44 may be provided with a skirt 48, which aesthetically matches skirt 42, but it is desired that there be a small notch 46 between skirts 42 and 48 in order to allow lid 16 to pivot. Although not shown in the figures, hamper compartment 12 may be provided with a smaller skirt of the same profile, which is positioned under cover skirt 48 so that skirt 48 may conveniently rest on this smaller skirt.

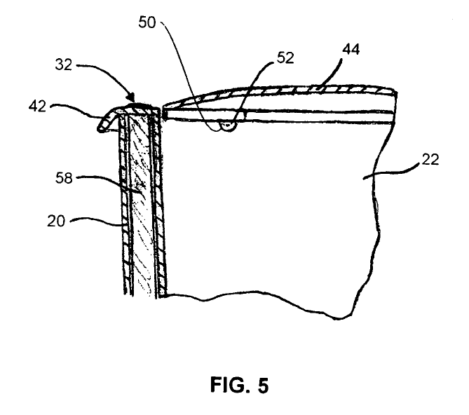

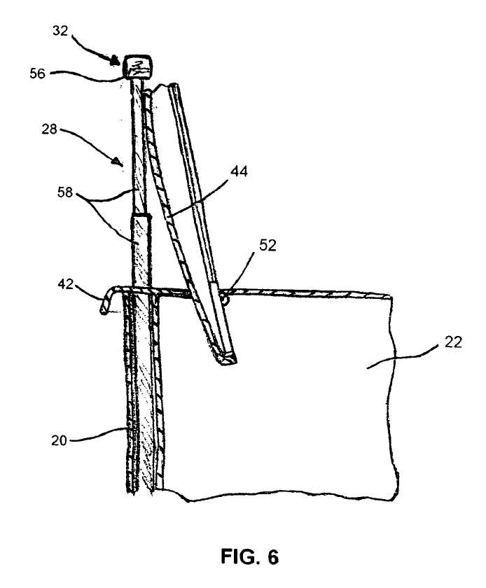

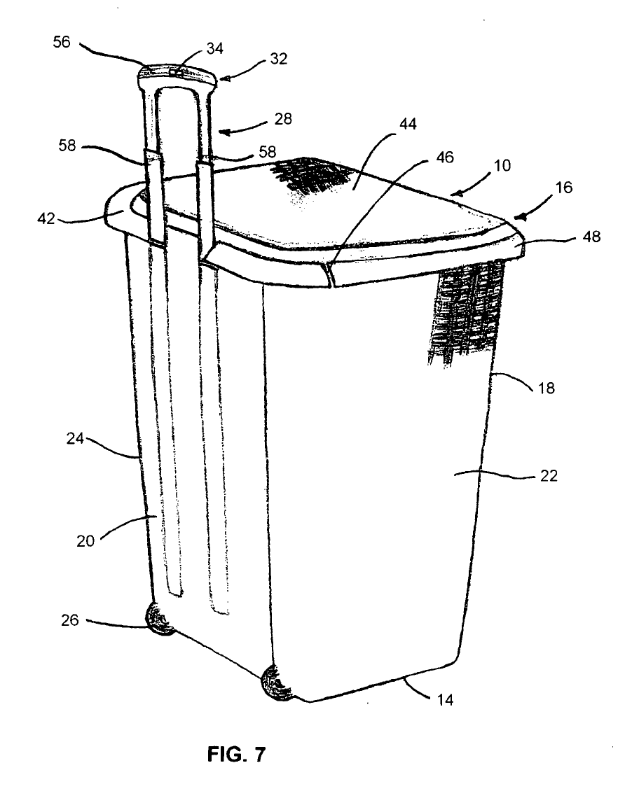

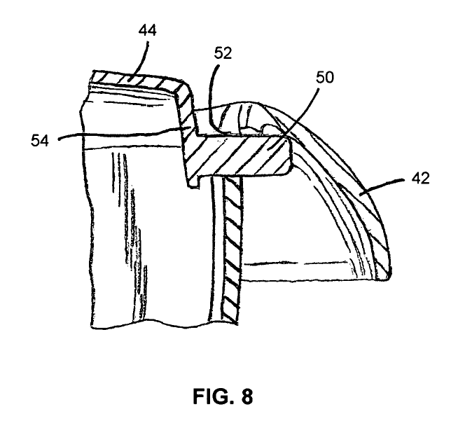

FIGS. 5-8 illustrate that exemplary skirt 42 may have a slot 50 near notch 46 wherein slot 50 may receive a respective pin 52, which extends laterally outward from a downwardly directed lip 54 carried by lid surface 44. In this exemplary embodiment, lid 16 can be lifted by grasping gripping tongue 40 such that lid 16 pivots about pins 52 to an open position as shown in FIG. 6. In so doing, notch 46 allows skirt 48 to clear skirt 42 without interference.

As seen in the various exemplary embodiments, telescoping handle assembly 28 includes a handle 32, which includes a grip 56 interconnecting two parallel opposed telescoping branches 58 and a lock-unlock button 34. Telescoping branches 58 may be secured within a side wall (e.g., side wall 18, 20, 22 or 24) of hamper 10, or alternatively, onto an interior/inner or exterior/outer surface of one or more side walls 18, 20, 22, 24. Although a desired locking mechanism is illustrated in the various figures, telescoping handle assembly 28 may move and adjust by any suitable means including friction, springs, pneumatics, etc. In the exemplary embodiments illustrated in FIGS. 1-4, handle 32 may be locked or unlocked by way of lock-unlock button 34 which, when depressed, disengages two spring biased push buttons or lugs 60 out of their respective lock slots 62 such that when button 34 is depressed, the handle can be adjusted up or down. Upon releasing button 34 after adjusting the handle to a desired position, the spring biased lugs will re-engage with lock slots 62 and lock the handle into position.

It is desirable for telescoping handle assembly 28 be able to be moved between at least two positions: a first position in which a major portion of a length of the telescoping handle assembly 28 is positioned below an upper periphery of the one or more vertical walls (e.g., as illustrated in FIG. 5) and a second position in which a major portion of a length of the telescoping handle assembly 28 is positioned above the upper periphery of the one or more vertical walls (e.g., as shown in FIGS. 1-3 and 6-7). When telescoping handle assembly 28 is in the upright or second position and lugs 60 are positioned in lock slots 62 to maintain handle assembly 28 in such a position, hamper 10 may be moved by grasping grip 56 of handle 32 and pulling hamper 10 toward the user such that hamper 10 is pivoted on the wheels 26 and the hamper can be moved to a new location. It is also within the scope of the invention to push hamper 10 in a suitable manner as one skilled in the art would recognize. Note that as shown in FIG. 6, lid 16 may be raised or lowered irrespective of the position of telescoping handle assembly 28.

The components of hamper 10 may be conveniently molded or shaped out of any suitable material, including, but not limited to, wood, plastic, metal, wicker, or any combination thereof, as would be evident to one skilled in the art. Telescoping handle assembly 28 may similarly be constructed of any suitable material though it is desired that the handle be constructed of a sturdy material such as aluminum, metal, or a firm plastic. It is further desired that the grip be covered in a material that is cushioned to provide a comfortable gripping surface for a user.

In one exemplary embodiment, hamper 10 comprises a bottom side wall and one or more vertical walls integrally connected to one another to from a single continuous structure. For example, bottom side wall and one or more vertical walls may be thermoformed from a plastic material (e.g., a polyolefin) to from a single continuous structure having a plurality of apertures therein.

In a further exemplary embodiment, hamper 10 may further comprise a liner 90, which is removably received by and sized so as to fit within hamper compartment 12 or hamper sub-compartment 27. As shown in FIG. 2, exemplary liner 90 may be positioned within hamper sub-compartment 27 and optionally attachable to skirt 42 or any other hamper structure near compartment opening 51 (e.g., liner attachment device 91, such as a VELCRO® fastener, along a surface of hamper sub-compartment 27 that is removably attachable to a corresponding attachment device 92 positioned along liner 90). Exemplary liner 90 may comprise any material suitable for forming liner 90 including, but not limited to, a netting material, and a cloth material (e.g., similar to a pillowcase design).

The present invention is further directed to a method of moving laundry. In one exemplary method of moving laundry, the method comprises (i) loading laundry into a hamper comprising at least one hamper compartment comprising a bottom side wall, one or more vertical walls extending upward from the bottom side wall, and a compartment opening positioned within a vertical wall or positioned opposite the bottom side wall, the compartment opening being sized so that one or more pieces of clothing can be inputted into the at least one hamper compartment through the compartment opening; two or more wheels affixed to the at least one hamper compartment so as to provide mobility to the at least one hamper compartment; and a telescoping handle assembly affixed to the one or more vertical walls, the telescoping handle assembly being movable from a first position in which a major portion of a length of the telescoping handle assembly is positioned below an upper periphery of the one or more vertical walls to a second position in which a major portion of a length of the telescoping handle assembly is positioned above the upper periphery of the one or more vertical walls; (ii) extending the telescoping handle assembly, if necessary, to move the telescoping handle assembly into the second position; and (iii) moving the hamper from one location to another location by pushing or pulling on the telescoping handle assembly.

The methods of moving laundry may further comprise one or more additional method steps. Suitable method steps include, but are not limited to, loading one or more laundry products (e.g., detergent, fabric softener, etc.) onto the hamper; lining a hamper compartment with a removable liner; inserting a divider into a hamper compartment to subdivide the hamper compartment into two or more hamper compartments; and removing a divider from a hamper compartment to reduce the number of hamper compartments within the hamper.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A hamper comprising:
at least one hamper compartment comprising:
a bottom side wall,
one or more vertical walls extending upward from said bottom side wall, and
a compartment opening positioned within a vertical wall or positioned opposite said bottom side wall, said compartment opening being sized so that one or more pieces of clothing can be inputted into said at least one hamper compartment through said compartment opening;
two or more wheels affixed to said at least one hamper compartment so as to provide mobility to said at least one hamper compartment; and
a telescoping handle assembly affixed to said one or more vertical walls, said telescoping handle assembly being movable from a first position in which a major portion of a length of said telescoping handle assembly is positioned below an upper periphery of said one or more vertical walls to a second position in which a major portion of a length of said telescoping handle assembly is positioned above the upper periphery of said one or more vertical walls.

2. The hamper of claim 1, wherein said bottom side wall, said one or more vertical walls, or both has a plurality of apertures therethrough.

3. The hamper of claim 1, wherein said telescoping handle assembly comprises:
a handle having a grip;
two spaced telescoping branches connected to said handle, said branches being telescopically mounted relative to said at least one hamper compartment; and
a locking mechanism capable of locking said branches and said handle in at least two positions.

4. The hamper of claim 3, wherein said two spaced telescoping branches extend within a vertical wall of said hamper such that when said telescoping handle assembly is in the first position, said two spaced telescoping branches are positioned between an outer surface of said vertical wall and an inner surface of said at least one hamper compartment, and are not visible.

5. The hamper of claim 1, wherein the hamper comprises at least two separate hamper compartments separated by at least one divider.

6. The hamper of claim 5, wherein said at least one divider is situated vertically extending upward from said bottom side wall.

7. The hamper of claim 5, wherein said at least one divider is removable.

8. The hamper of claim 1, further comprising a pocket along said one or more vertical walls suitable for storing laundry cleaning supplies.

9. The hamper of claim 1, further comprising a drawer suitable for storing laundry cleaning supplies.

10. The hamper of claim 1, further comprising a cover portion, said cover portion including a lid to cover said compartment opening.

11. The hamper of claim 1, wherein said bottom side wall, said one or more vertical walls, or both comprises a material selected from the group comprising wicker, plastic, wood, metal, and combinations thereof.

12. The hamper of claim 1, wherein said one or more vertical walls comprises a first side wall, a second side wall, a front wall and a back wall, and wherein said telescoping handle assembly is attached to an outside surface of the back wall.

13. The hamper of claim 2, wherein said plurality of apertures have an average aperture area of at least about ¼ square inch.

14. The hamper of claim 2, wherein said plurality of apertures have an average aperture area of at least about 1 square inch.

15. The hamper of claim 1, wherein said bottom side wall and said one or more vertical walls comprise a single continuous structure.

16. The hamper of claim 1, wherein said telescoping handle comprises a material selected from the group consisting of aluminum, metal, plastic, wood, and combinations thereof.

17. The hamper of claim 10, wherein said cover portion is pivotably attached to said at least one hamper compartment.

18. The hamper of claim 3, wherein said handle is locked in a given position by one or more spring-biased push buttons.

19. The hamper of claim 1, further comprising a liner which is removably received by and sized so as to fit within said at least one hamper compartment.

20. A method of moving laundry, said method comprising the steps of:
loading laundry into a hamper comprising:
at least one hamper compartment comprising:
a bottom side wall,
one or more vertical walls extending upward from said bottom side wall, and
a compartment opening positioned within a vertical wall or positioned opposite said bottom side wall, said compartment opening being sized so that one or more pieces of clothing can be inputted into said at least one hamper compartment through said compartment opening;
two or more wheels affixed to said at least one hamper compartment so as to provide mobility to said at least one hamper compartment; and
a telescoping handle assembly affixed to said one or more vertical walls, said telescoping handle assembly being movable from a first position in which a major portion of a length of said telescoping handle assembly is positioned below an upper periphery of said one or more vertical walls to a second position in which a major portion of a length of said telescoping handle assembly is positioned above the upper periphery of said one or more vertical walls;
extending the telescoping handle assembly, if necessary, to move the telescoping handle assembly into the second position; and
moving the hamper from one location to another location by pushing or pulling on the telescoping handle assembly.
